(19) United States
(12) Patent Application Publication
(10) Pub. No.: US 2011/0076990 A1
(43) Pub. Date: Mar. 31, 2011

(54) METHOD FOR RECORDING MOBILE PHONE CALLS

(76) Inventor: Christopher Anthony SILVA, Little Egg Harbor, NJ (US)

(21) Appl. No.: 12/892,110

(22) Filed: Sep. 28, 2010

Related U.S. Application Data
(60) Provisional application No. 61/246,783, filed on Sep. 29, 2009.

(51) Int. Cl. H04L 12/58

(52) U.S. Cl. 455/412.1

(57) ABSTRACT

The present invention generally relates to a system and method for recording mobile phone calls for record keeping. The present invention utilizes a software call-recording application installed on the mobile phone to make a direct connection to a centralized recording server utilizing a conference or three-way calling feature on the mobile phone. The centralized recording server can answer the incoming call from the mobile phone. The recording server can then capture the audio and any data and store the audio and data for future use.

### CROSS REFERENCE TO RELATED APPLICATION

This application claims the benefit of U.S. Provisional Patent Application No. 61/246,783, filed Sep. 29, 2009, the entirety of which is hereby incorporated by reference into this application.

### BACKGROUND OF THE INVENTION

1. Field of the Invention

The present invention generally relates to data recording a mobile phone call conversation in which an incoming or outgoing call is automatically conferenced to a centralized recording server and audio from the internal call can be captured and stored.

2. Description of Related Art

Systems which record conversations of calls are known. U.S. Pat. No. 7,502,448 directed to an apparatus and system for transmitting, receiving and recording two-way conversation data over a wireless network via a wireless communication device. A memory is coupled to the wireless communication device for storing two-way conversation data in digital form. A device interface transfers conversation information from the wireless communication device to a remote storage device. A user interface is configured to allow a user of the wireless communication device to access, by way of a wireless network, the two-way conversation data stored in the remote storage device. The user interface includes a plurality of data management functions that allows the user of the wireless communication device to manage, by way of the wireless network, the two-way conversation data stored in the remote storage device. The data management function includes functions for editing and translating the two-way conversation data stored in the remote storage device, such as searching, linking, downloading, editing, playing back, converting, sending, archiving, and deleting the two-way conversation data stored in the storage location.

WO 2009/040706 is related to conversation recording on mobile telephones with subsequent transfer to a central database. A telecommunication system for managing telecommunication data includes a mobile telephone communication device that is able to make and receive telephone calls via a public telephone network and which has a storage arrangement for storing a telephone communication during a telephone session. A processing facility processes the telephone communication. A transferring means transfers the stored telephone communication from the mobile telephone communication device to the processing facility. The transfer can take place automatically, immediately after the telephone session ends or at a later time, as determined by a user of the telephone. Also, the user can decide whether or not to delete the stored telephone communication. If the user decides to transfer the telephone communication immediately after the telephone session ends, this will be effected via a communication channel using the cellular public telephone network and gateway, and a data transmission.

It is desirable to provide a method a system for mobile phone recording in which audio can be automatically forwarded or delivered when desired to a central server for audio recording.

### SUMMARY OF THE INVENTION

The present invention generally relates to a system and method for recording mobile phone calls for record keeping. Embodiments of the present invention can include a central server for audio recording of mobile phone conference calls.

Mobile phones are becoming more and more prevalent for organizations of all types. It is desirable for organizations to record the audio conversations occurring on mobile phones. The present invention utilizes a software call-recording application installed on the mobile phone to make a direct connection to a centralized recording server utilizing a conference or three-way calling feature on the mobile phone. The centralized recording server can answer the incoming call from the mobile phone on any type of equipment used to provide voice communication over distances, such as traditional time-division multiplexing (TDM) and voice over internet (VOIP).

When an audio call is initiated, incoming or outgoing, on the mobile phone, the mobile phone connects to a centralized recording server via TDM, VOIP, or other telephony, by utilizing a conference or three-way calling capability of the mobile phone to deliver the audio to the centralized recording server where it will be recorded. The conference and connection to the recording server can be set to be automatic, requiring no intervention by the mobile phone user. Alternatively, the user can set a call recording application on the mobile phone to deliver the audio only when desired.

Mobile phones have an inherent capability to conference or have three or more parties involved on a call. The call recording application utilizes the conference capability and automatically or on demand, connects the mobile phone call to a recording server via conventional telephony means (wireless or TDM), via VOIP, or other telephony means to include the recording server as a third party to the mobile phone call. The recording server can then capture the audio and any data presented and store the data for future use. Individuals or organizations can install the call recording application on the mobile phone and program it with the telephone number to dial to make the third party connection to a recording server.

The invention will be more fully described by reference to the following drawings.

### BRIEF DESCRIPTION OF THE DRAWINGS

FIG. 1 is a flowchart of a method for recording cell phone conference calls in accordance with an embodiment of the present invention.

FIG. 2 is a schematic diagram of system for recording a mobile phone call conversation.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

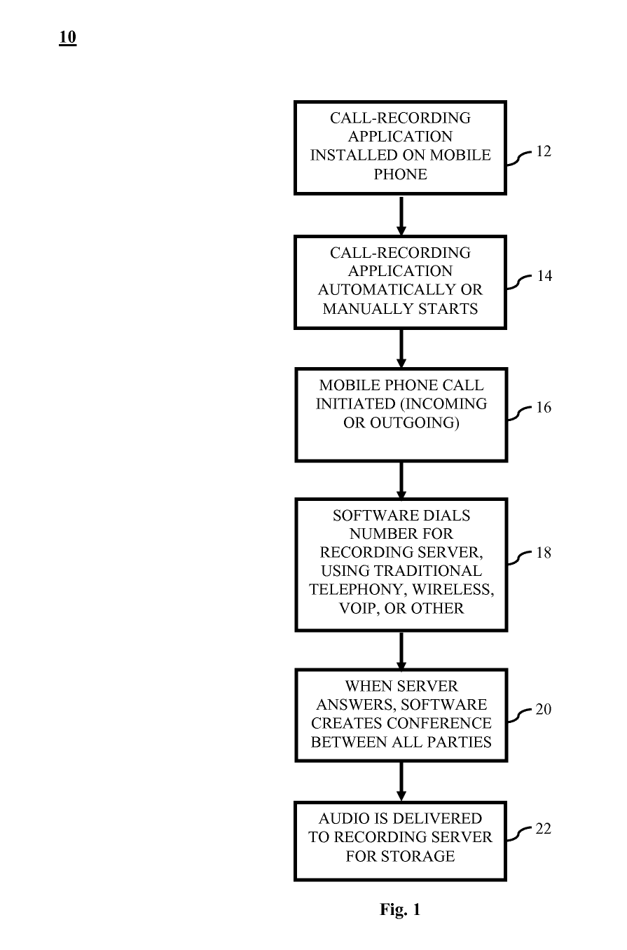

FIG. 1 is a flowchart 10 that shows the process of recording audio from a mobile phone call conversation, in accordance with the teachings of the present invention. In block 12, a call-recording application can be installed on a wireless phone, such as a mobile phone. In block 14, the call-recording application can start either automatically or manually. The call-recording application can include an interface for the user or can be undetectable to the user. In block 16, an external call to another phone can be initiated or received by the wireless phone including the call-recording application. In block 18, the call-recording application can establish a conference call to a recording server The call recording application utilizes the conference capability of the mobile phone to call a number of a recording server via conventional telephony means (wireless or TDM), via VOIP, or other telephony means. The call-recording application can be programmed with a telephone number of the recording server. In block 20, after the server answers, the call recording application includes the recording server as a third party to the mobile phone call between the parties. In block 22, audio from the call is delivered to the recording server. The recording server can write the audio to storage at the recording server.

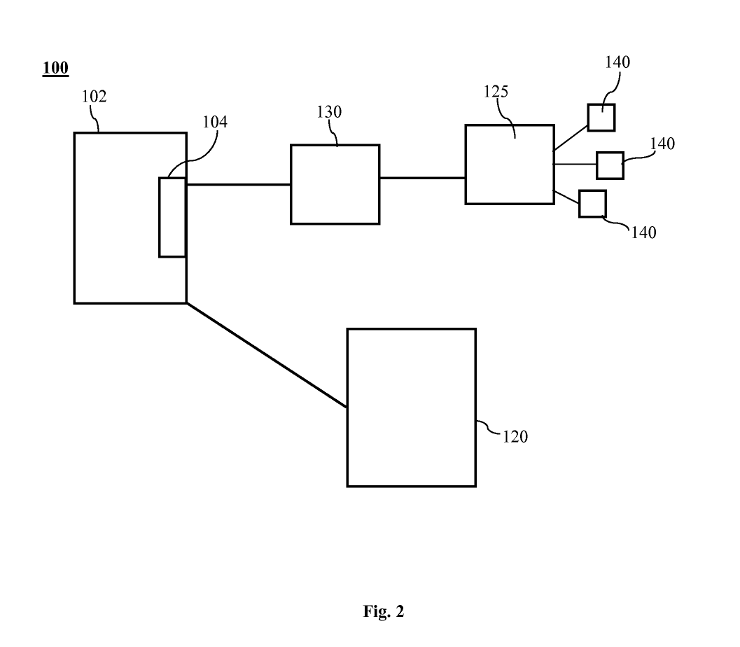

FIG. 2 is a schematic diagram of system for recording a phone call 100. Wireless phone 102 includes call-recording application 104. Preferably, wireless phone 102 is a mobile phone. Phone 120 can establish a call to wireless phone 102 or wireless phone 102 can receive a call from phone 120. Phone 120 can be either a landline connected telephone or a mobile phone. Call-recording application 104 establishes a conference with recording server 130. Recording server 120 includes storage 125 for storing audio of the established conference call. For example, storage 125 can include one or more third-party recorder databases 140.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A method for recording a mobile phone conference call between two or more parties comprising the steps of:
establishing an external call between a first phone and a second phone;
conferencing a recording server to the external call;
capturing an audio signal from the external call at said recording server; and
recording the captured audio signal at the recording server.

2. The method of claim 1 wherein said step of conferencing a recording server comprises the first phone initiating a call with the recording server and establishing a conference call between the first phone and the recording server.

3. The method of claim 2 wherein the conference call is established as a three way call between the first phone, the second phone and the recording server.

4. The method of claim 1 wherein said step of conferencing a recording server is performed automatically.

5. The method of claim 1 wherein said step of conferencing a recording sever is performed on demand.

6. The method of claim 1 wherein said step of conferencing a recording server comprises connecting the first phone to the recording server using time-division multiplexing.

7. The method of claim 1 wherein said step of conferencing a recording server comprises connecting the first phone to the recording server using voice over internet.

8. The method of claim 1 wherein said step of recording the captured audio signal comprises transferring the captured audio signal to one or more third party recorder databases.

9. The method of claim 1 wherein the first phone is a mobile phone.

10. A system for recording a mobile phone conference call between two or more parties comprising:
means for establishing an external call between a first phone and a second phone;
means for conferencing a recording server to the external call;
means for capturing an audio signal from the external call at said recording server; and
means for recording the captured audio signal at the recording server.

11. The system of claim 10 wherein said means for conferencing a recording server comprises the first phone initiating a call with the recording server and establishing a conference call between the first phone and the recording server.

12. The system of claim 11 wherein the conference call is established as a three way call between the first phone, the second phone and the recording server.

13. The system of claim 10 wherein said means for conferencing a recording server is performed automatically.

14. The system of claim 10 wherein said means for conferencing a recording sever is performed on demand.

15. The system of claim 10 wherein said means for conferencing a recording server comprises connecting the first phone to the recording server using time-division multiplexing.

16. The system of claim 10 wherein said means for conferencing a recording server comprises connecting the first phone to the recording server using voice over internet.

17. The system of claim 10 wherein said means for recording the captured audio signal comprises transferring the captured audio signal to one or more third party recorder databases.

18. The system of claim 10 wherein the first phone is a mobile phone.
